(19) United States
(12) Patent Application Publication
(10) Pub. No.: US 2026/0304336 A1
(43) Pub. Date: Oct. 1, 2026

(54) Switching Period with Timing Advance

(71) Applicant: Apple Inc., Cupertino, CA (US)

(72) Inventors: Ankit Bhamri, Haar (DE); Wei Zeng, Saratoga, CA (US); Yang Tang, San Jose, CA (US); Emmanuel Ngompe, Rancho Mission Viejo, CA (US); Haitong Sun, Saratoga, CA (US); Dawei Zhang, Saratoga, CA (US); Qiming Li, Beijing (CN); Anatoliy S loffe, Sunnyvale, CA (US)

(21) Appl. No.: 19/474,986

(22) PCT Filed: May 9, 2023
(86) PCT No.: PCT/CN2023/093005

§ 371 Date: Oct. 13, 2025

(51) Int. Cl. H04W 56/00; H04W 72/231

(52) U.S. Cl. CPC H04W 56/0045; H04W 56/009; H04W 72/231

(57) ABSTRACT

Apparatuses, systems, and methods for determining and applying switching periods, e.g., incorporating timing advance, e.g., in 5G NR systems and beyond. A UE and network may determine one or more base switching period and one or more time adjustment value related to timing advance. An adjusted switching period may be determined based on a combination of a base switching period and a time adjustment value. The network may avoid transmitting to the UE during the adjusted switching period. The UE may perform an uplink transmission switch during the base switching period.

### FIELD

The invention relates to wireless communications, and more particularly to apparatuses, systems, and methods for determining and applying switching periods, e.g., in cellular systems, such as LTE systems, 5G NR systems, and beyond.

### DESCRIPTION OF THE RELATED ART

Wireless communication systems are rapidly growing in usage. In recent years, wireless devices such as smart phones, wearable devices or accessory devices), and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for determining and applying switching periods e.g., in 5G NR systems and beyond.

In some embodiments, a method may comprise: receiving, from a cellular network, configuration information for determination of adjusted switching period for uplink transmission switching based on timing advance. The method may further comprise receiving, from the cellular network, scheduling information scheduling: a first uplink (UL) transmission on a first band; and a second UL transmission on a second band different from the first band. The method may further comprise determining a first adjusted switching period between the first UL transmission and the second UL transmission, the first adjusted switching period based on a base switching period adjusted by a first time adjustment value related to timing advance. The method may further comprise: transmitting, to the cellular network, the first UL transmission on the first band and receiving, from the cellular network, a first downlink (DL) transmission after transmission of the first UL transmission. The method may further comprise,
during the first adjusted switching period, switching a transmitter to the second band, wherein the first adjusted switching period is after reception of the first DL transmission and transmitting, to the cellular network, the second UL transmission on the second band after the first adjusted switching period. In some embodiments, more than one band may be used simultaneously, and the adjusted switching period may be based on and applied to multiple bands.

In some embodiments, a method may comprise: transmitting, to a user equipment (UE), configuration information for determination of adjusted switching period based on timing advance. The method may further comprise transmitting, to the UE, scheduling information scheduling: a first uplink (UL) transmission on a first band; and a second UL transmission on a second band different from the first band. The method may further comprise determining a first adjusted switching period between the first UL transmission and the second UL transmission, the first adjusted switching period based on a base switching period adjusted by a first time adjustment value related to timing advance. The method may further comprise: receiving, from the UE, the first UL transmission on the first band; transmitting, to the UE, a first downlink (DL) transmission after reception of the first UL transmission and prior to the first adjusted switching period; and receiving, from the UE, the second UL transmission on the second band after the first adjusted switching period. In some embodiments, more than one band may be used simultaneously, and the adjusted switching period may be based on and applied to multiple bands.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6A illustrates an example of a 5G network architecture that incorporates both 3GPP (e.g., cellular) and non-3GPP (e.g., non-cellular) access to the 5G CN, according to some embodiments.

FIG. 6B illustrates an example of a 5G network architecture that incorporates both dual 3GPP (e.g., LTE and 5G NR) access and non-3GPP access to the 5G CN, according to some embodiments.

FIG. 7 illustrates an example of a baseband processor architecture for a UE, according to some embodiments.

FIG. 8 illustrates a flow diagram of an example of a method for determining and applying switching periods, according to some embodiments.

FIGS. 9-15 illustrate exemplary aspects of determining and applying switching periods, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
DL: Downlink
UL: Uplink
LTE: Long Term Evolution
NR: New Radio
5GS: 5G System
5GMM: 5GS Mobility Management
5GC/5GCN: 5G Core Network
IE: Information Element
CE: Control Element
MAC: Medium Access Control
SSB: Synchronization Signal Block
CSI: Channel State Information
CSI-RS: Channel State Information Reference Signal
CMR: Channel Measurement Resource
PDCCH: Physical Downlink Control Channel
PDSCH: Physical Downlink Shared Channel
RRC: Radio Resource Control
RRM: Radio Resource Management
CORESET: Control Resource Set
TCI: Transmission Configuration Indicator
DCI: Downlink Control Information

### Terms

The following is a glossary of terms used in this disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAS, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.
Base Station—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.
Band—The term “band” has the full breadth of its ordinary meaning, and at least includes a section of spectrum (e.g., radio frequency spectrum) in which channels are used or set aside for the same purpose.
Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.
Non-3GPP Access-refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

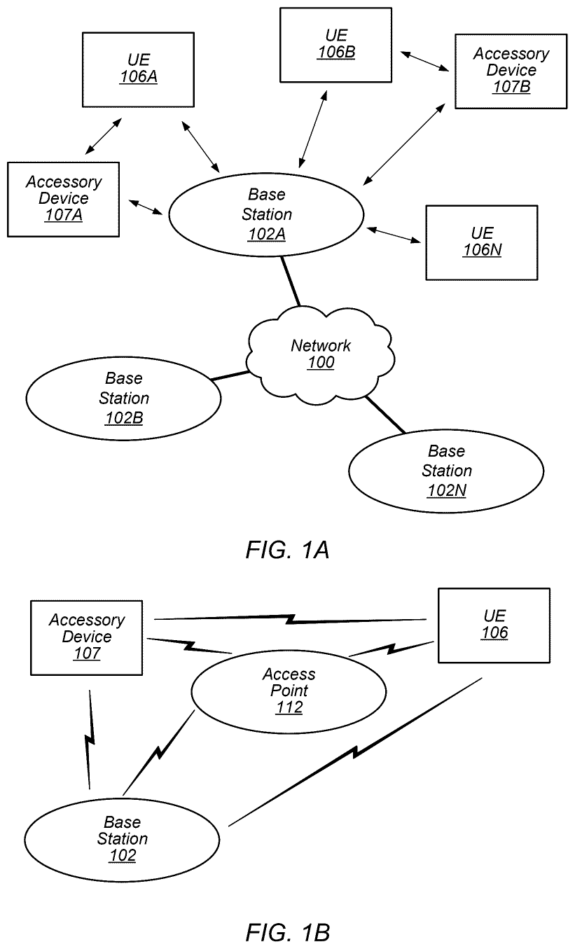

### FIGS. 1a and 1b: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more wireless devices, such as user devices 106A, 106B, etc., through 106N, as well as accessory devices, such as user devices 107A, 107B. Each of the user devices may be referred to herein as a “user equipment” (UE). Thus, the user devices 106 and 107 are referred to as UEs or UE devices.

The base station (BS) 102A may be a base transceiver station (BTS) or cell site (a “cellular base station”) and may include hardware that enables wireless communication with the UEs 106A through 106N as well as UEs 107A and 107B.

The communication area (or coverage area) of the base station may be referred to as a “cell.” The base station 102A and the UEs 106/107 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA 2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106/107 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106/107 as illustrated in FIG. 1, each UE 106/107 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106/107 may be capable of communicating using multiple wireless communication standards. For example, the UE 106/107 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106/107 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Note that accessory devices 107A/B may include cellular communication capability and hence are able to directly communicate with cellular base station 102A via a cellular RAT. However, since the accessory devices 107A/B are possibly one or more of communication, output power, and/or battery limited, the accessory devices 107A/B may in some instances selectively utilize the UEs 106A/B as a proxy for communication purposes with the base station 102Aand hence to the network 100. In other words, the accessory devices 107A/B may selectively use the cellular communication capabilities of its companion device (e.g., UEs 106A/B) to conduct cellular communications. The limitation on communication abilities of the accessory devices 107A/B may be permanent, e.g., due to limitations in output power or the RATs supported, or temporary, e.g., due to conditions such as current battery status, inability to access a network, or poor reception.

FIG. 1B illustrates user equipment 106 (e.g., one of the devices 106A through 106N) and accessory device (or user equipment) 107 (e.g., one of the devices 107A or 107B) in communication with a base station 102 and an access point 112 as well as one another, according to some embodiments. The UEs 106/107 may be devices with both cellular communication capability and non-cellular communication capability (e.g., Bluetooth, Wi-Fi, and so forth) such as a mobile phone, a wearable device, a hand-held device, a computer or a tablet, or virtually any type of wireless device. The accessory device 107 may be a wearable device such as a smart watch. The accessory device 107 may comprise cellular communication capability and be capable of directly communicating with the base station 102 as shown. Note that when the accessory device 107 is configured to directly communicate with the base station, the accessory device may be said to be in “autonomous mode.” In addition, the accessory device 107 may also be capable of communicating with another device (e.g., UE 106), referred to as a proxy device, intermediate device, or companion device, using a short-range communications protocol; for example, the accessory device 107 may according to some embodiments be “paired” with the UE 106, which may include establishing a communication channel and/or a trusted communication relationship with the UE 106. Under some circumstances, the accessory device 107 may use the cellular functionality of this proxy device for communicating cellular voice and/or data with the base station 102. In other words, the accessory device 107 may provide voice and/or data packets intended for the base station 102 over the short-range link to the UE 106, and the UE 106 may use its cellular functionality to transmit (or relay) this voice and/or data to the base station on behalf of the accessory device 107. Similarly, the voice and/or data packets transmitted by the base station and intended for the accessory device 107 may be received by the cellular functionality of the UE 106 and then may be relayed over the short-range link to the accessory device. As noted above, the UE 106 may be a mobile phone, a tablet, or any other type of hand-held device, a media player, a computer, a laptop or virtually any type of wireless device. Note that when the accessory device 107 is configured to indirectly communicate with the base station 102 using the cellular functionality of an intermediate or proxy device, the accessory device may be said to be in “relay mode.”

The UE 106/107 may include a processor that is configured to execute program instructions stored in memory. The UE 106/107 may perform any of the method embodiments described herein by executing such stored instructions. Alternatively, or in addition, the UE 106/107 may include a programmable hardware element such as an FPGA (field-programmable gate array) that is configured to perform any of the method embodiments described herein, or any portion of any of the method embodiments described herein.

The UE 106/107 may include one or more antennas for communicating using one or more wireless communication protocols or technologies. In some embodiments, the UE 106 may be configured to communicate using, for example, CDMA2000 (1xRTT/1xEV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106/107 may share one or more parts of a receive and/or transmit chain between multiple wireless communication technologies, such as those discussed above.

In some embodiments, the UE 106/107 may include separate transmit and/or receive chains (e.g., including separate antennas and other radio components) for each wireless communication protocol with which it is configured to communicate. As a further possibility, the UE 106/107 may include one or more radios which are shared between multiple wireless communication protocols, and one or more radios which are used exclusively by a single wireless communication protocol. For example, the UE 106/107 might include a shared radio for communicating using either of LTE or 5G NR (or LTE or 1xRTTor LTE or GSM), and separate radios for communicating using each of Wi-Fi and Bluetooth. Other configurations are also possible.

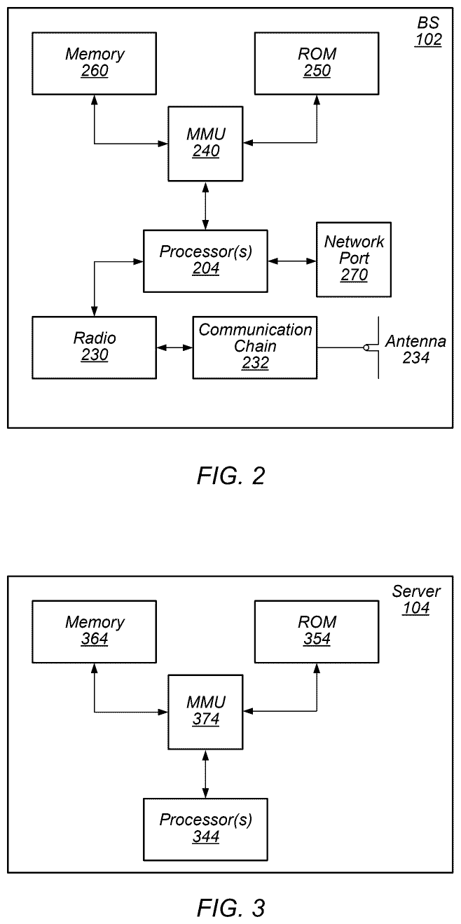

### FIG. 2: Block Diagram of a Base Station

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (Ics) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (Ics) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (Ics) that are configured to perform the functions of processor(s) 344. In addition, each integrated circuit may include circuitry (e.g., first circuitry, second circuitry, etc.) configured to perform the functions of processor(s) 344.

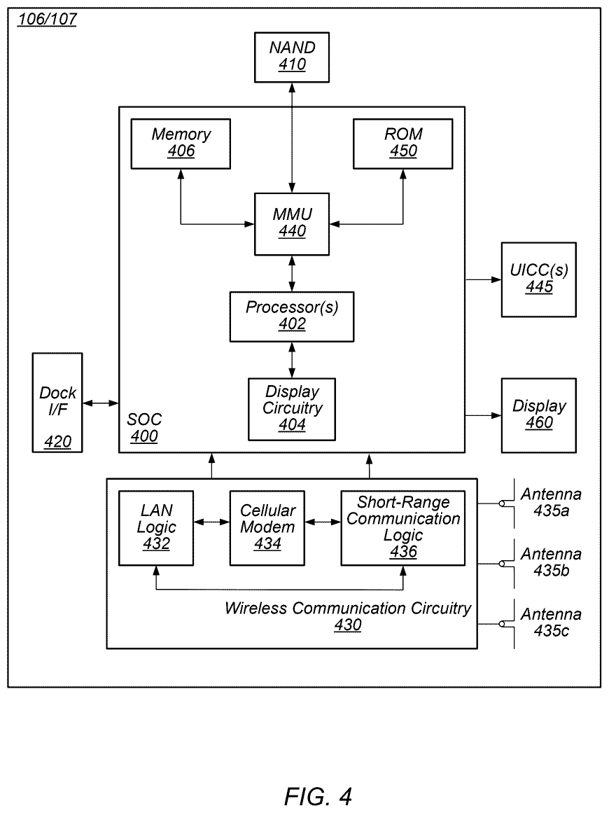

### FIG. 4: Block Diagram of a UE

FIG. 4 illustrates an example simplified block diagram of a communication device 106/107, according to some embodiments. It is noted that the block diagram of the communication device of FIG. 4 is only one example of a possible communication device. According to embodiments, communication device 106/107 may be a user equipment (UE) device, a mobile device or mobile station, a wireless device or wireless station, a desktop computer or computing device, a mobile computing device (e.g., a laptop, notebook, or portable computing device), a wearable device, a tablet, an unmanned aerial vehicle (UAV), a UAV controller (UAC) and/or a combination of devices, among other devices. As shown, the communication device 106/107 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106/107 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106/107, and wireless communication circuitry 430. The wireless communication circuitry 430 may include a cellular modem 434 such as for 5G NR, LTE, GSM, etc., and short to medium range wireless communication logic 436 (e.g., Bluetooth™ and WLAN circuitry). In some embodiments, communication device 106/107 may include wired communication circuitry (not shown), such as a network interface card, e.g., for Ethernet.

The wireless communication circuitry 430 may couple (e.g., communicatively; directly or indirectly) to one or more antennas, such as antennas 435a, 435b, and 435c (e.g., 435a-c) as shown. The wireless communication circuitry 430 may include local area network (LAN) logic 432, the cellular modem 434, and/or short-range communication logic 436. The LAN logic 432 may be for enabling the UE device 106/107 to perform LAN communications, such as Wi-Fi communications on an 802.11 network, and/or other WLAN communications. The short-range communication logic 436 may be for enabling the UE device 106/107 to perform communications according to a short-range RAT, such as Bluetooth or UWB communications. In some scenarios, the cellular modem 434 may be a lower power cellular modem capable of performing cellular communication according to one or more cellular communication technologies.

In some embodiments, as further described below, cellular modem 434 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular modem 434 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106/107 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106/107 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106/107 may include at least two SIMs. Each SIM may execute one or more SIM applications and/or otherwise implement SIM functionality. Thus, each SIM may be a single smart card that may be embedded, e.g., may be soldered onto a circuit board in the UE 106/107, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106/107 may include a combination of removable smart cards and fixed/non-removable smart cards (such as one or more eUICC cards that implement eSIM functionality), as desired. For example, the UE 106/107 may comprise two embedded SIMs, two removable SIMs, or a combination of one embedded SIMs and one removable SIMs. Various other SIM configurations are also contemplated.

As noted above, in some embodiments, the UE 106/107 may include two or more SIMs. The inclusion of two or more SIMs in the UE 106/107 may allow the UE 106/107 to support two different telephone numbers and may allow the UE 106/107 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106/107 comprises two SIMs, the UE 106/107 may support Dual SIM Dual Active (DSDA) functionality. The DSDA functionality may allow the UE 106/107 to be simultaneously connected to two networks (and use two different RATs) at the same time, or to simultaneously maintain two connections supported by two different SIMs using the same or different RATs on the same or different networks. The DSDA functionality may also allow the UE 106/107 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106/107 may support Dual SIM Dual Standby (DSDS) functionality. The DSDS functionality may allow either of the two SIMs in the UE 106/107 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for determining and applying switching periods, e.g., in 5G NR systems and beyond, as further described herein.

As described herein, the communication device 106/107 may include hardware and software components for implementing the above features for a communication device 106/107 to communicate a scheduling profile for power savings to a network. The processor 402 of the communication device 106/107 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (Ics) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (Ics) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more Ics that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

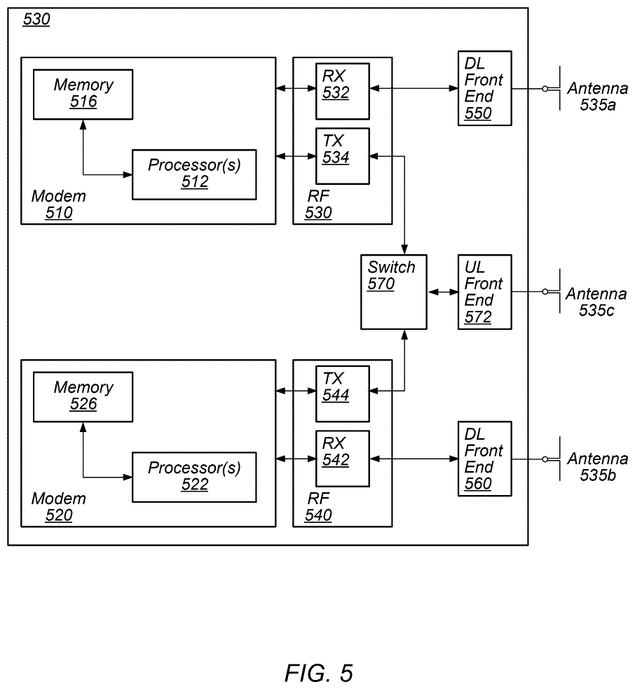

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular modem circuitry 434, may be included in a communication device, such as communication device 106/107 described above. As noted above, communication device 106/107 may be a user equipment (UE) device, a mobile device or mobile station, a wireless device or wireless station, a desktop computer or computing device, a mobile computing device (e.g., a laptop, notebook, or portable computing device), a tablet, a wearable device, and/or a combination of devices, among other devices.

The cellular communication circuitry 530 may couple (e.g., communicatively; directly or indirectly) to one or more antennas, such as antennas 535a-c (which may be antennas 435a-c of FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 535a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 535b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 535c. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 530 may be configured to perform methods for determining and applying switching periods, e.g., in 5G NR systems and beyond, as further described herein.

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 535a-c may be configured to implement part or all of the features described herein.

In addition, as described herein, processors 512 may include one or more processing elements. Thus, processors 512 may include one or more integrated circuits (Ics) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for determining and applying switching periods, e.g., in 5G NR systems and beyond, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 535a-c may be configured to implement part or all of the features described herein.

In addition, as described herein, processors 522 may include one or more processing elements. Thus, processors 522 may include one or more integrated circuits (Ics) that are configured to perform the functions of processors 522. In addition, each integrated circuit may include circuitry (e.g., first circuitry, second circuitry, etc.) configured to perform the functions of processors 522.

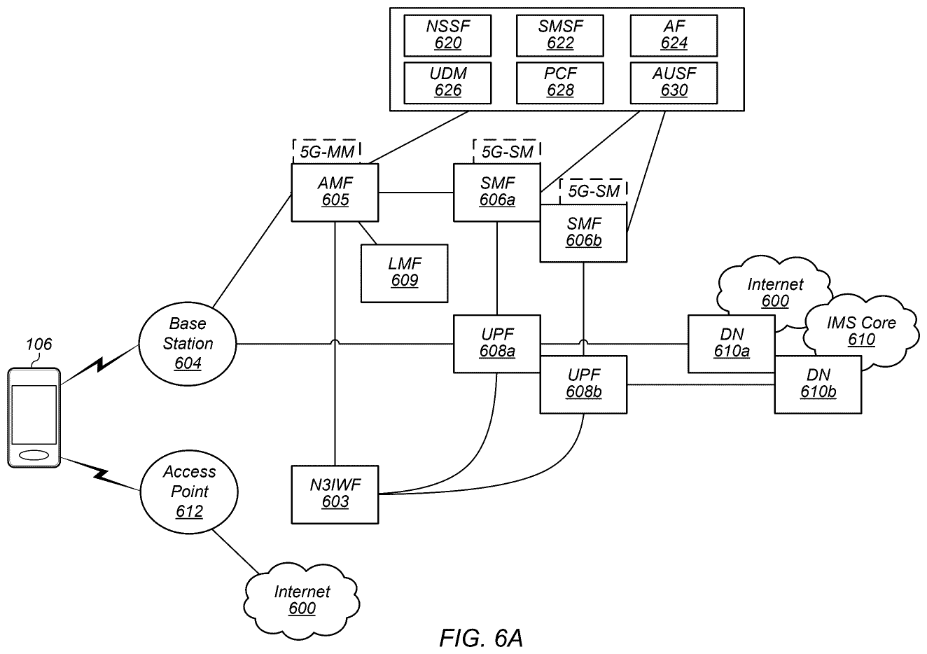

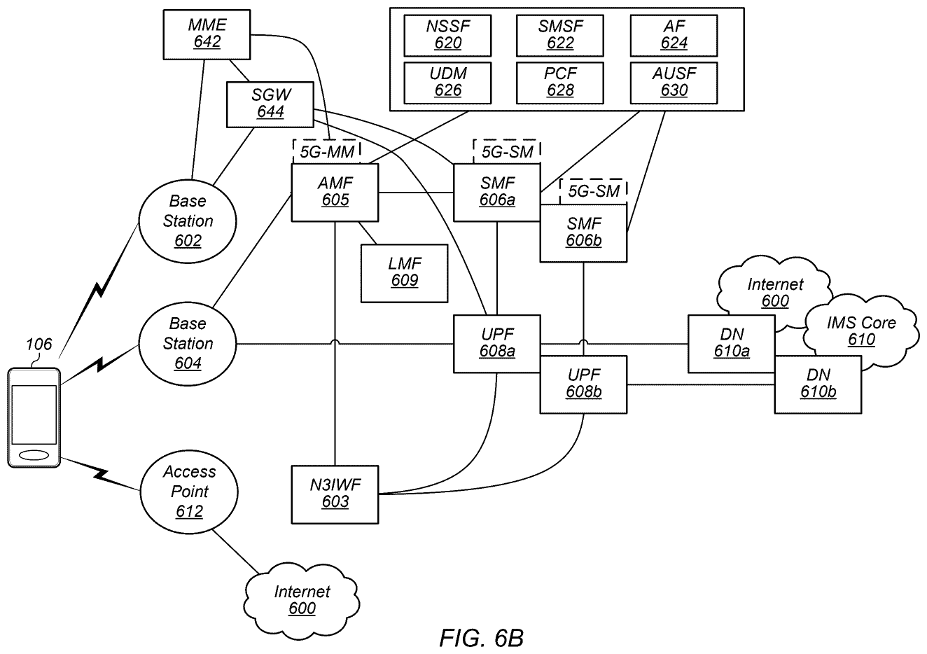

### FIG. 6a, 6b and 7: 5G Core Network Architecture—Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 6A illustrates an example of a 5G network architecture that incorporates both 3GPP (e.g., cellular) and non-3GPP (e.g., non-cellular) access to the 5G CN, according to some embodiments. As shown, a user equipment device (e.g., such as UE 106) may access the 5G CN through both a radio access network (RAN, e.g., such as gNB 604, which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106/107. In addition, the RAN (e.g., gNB 604) may also have a connection to the AMF 605. Thus, the 5G CN may support unified authentication over both connections as well as allow simultaneous registration for UE 106/107 access via both gNB 604 and AP 612. As shown, the AMF 605 may be in communication with a location management function (LMF) 609 via a networking interface, such as an NLs interface. The LMF 609 may receive measurements and assistance information from the RAN (e.g., gNB 604) and the UE (e.g., UE 106) via the AMF 605. The LMF 609 may be a server (e.g., server 104) and/or a functional entity executing on a server. Further, based on the measurements and/or assistance information received from the RAN and the UE, the LMF may determine a location of the UE. In addition, the AMF 605 may include one or more functional entities associated with the 5G CN (e.g., network slice selection function (NSSF) 620, short message service function (SMSF) 622, application function (AF) 624, unified data management (UDM) 626, policy control function (PCF) 628, and/or authentication server function (AUSF) 630). Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

FIG. 6B illustrates an example of a 5G network architecture that incorporates both dual 3GPP (e.g., LTE and 5G NR) access and non-3GPP access to the 5G CN, according to some embodiments. As shown, a user equipment device (e.g., such as UE 106) may access the 5G CN through both a radio access network (RAN, e.g., such as gNB 604 or eNB 602, which may be a base station 102) and an access point, such as AP 612. The AP 612 may include a connection to the Internet 600 as well as a connection to the N3IWF 603 network entity. The N3IWF may include a connection to the AMF 605 of the 5G CN. The AMF 605 may include an instance of the 5G MM function associated with the UE 106/107. In addition, the RAN (e.g., gNB 604) may also have a connection to the AMF 605. Thus, the 5G CN may support unified authentication over both connections as well as allow simultaneous registration for UE 106/107 access via both gNB 604 and AP 612. In addition, the 5G CN may support dual-registration of the UE on both a legacy network (e.g., LTE via eNB 602) and a 5G network (e.g., via gNB 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may be in communication with an LMF 609 via a networking interface, such as an NLs interface, e.g., as described above, and may include one or more functional entities associated with the 5G CN (e.g., NSSF 620, SMSF 622, AF 624, UDM 626, PCF 628, and/or AUSF 630). Note that UDM 626 may also include a home subscriber server (HSS) function and the PCF may also include a policy and charging rules function (PCRF). Note further that these functional entities may also be supported by the SMF606a and the SMF 606b of the 5G CN. The AMF 606 may be connected to (or in communication with) the SMF 606a. Further, the gNB 604 may in communication with (or connected to) the UPF 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and IMS core network 610.

Note that in various embodiments, one or more of the above-described network entities may be configured to perform methods for determining and applying switching periods, e.g., in 5G NR systems and beyond, e.g., as further described herein.

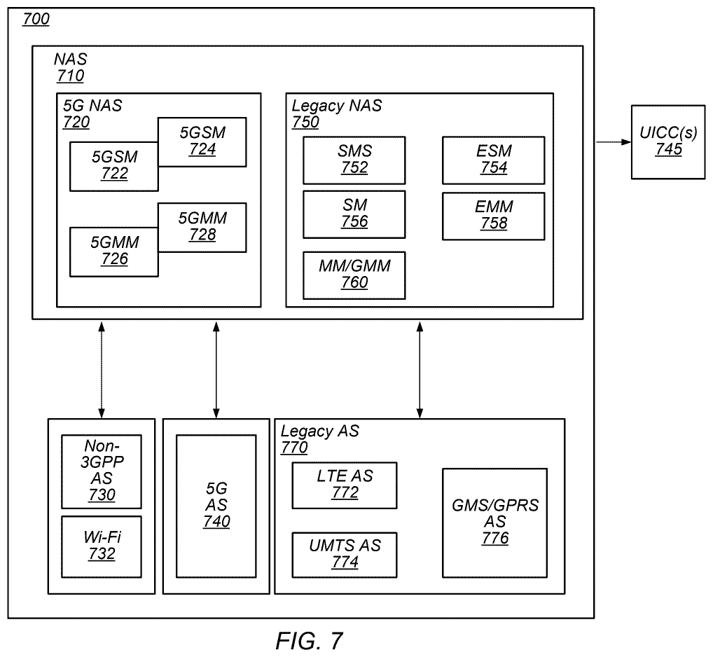

FIG. 7 illustrates an example of a baseband processor architecture for a UE (e.g., such as UE 106), according to some embodiments. The baseband processor architecture 700 described in FIG. 7 may be implemented on one or more radios (e.g., radios 429 and/or 430 described above) or modems (e.g., modems 510 and/or 520) as described above. As shown, the non-access stratum (NAS) 710 may include a 5G NAS 720 and a legacy NAS 750. The legacy NAS 750 may include a communication connection with a legacy access stratum (AS) 770. The 5G NAS 720 may include communication connections with both a 5G AS 740 and a non-3GPP AS 730 and Wi-Fi AS 732. The 5G NAS 720 may include functional entities associated with both access stratums. Thus, the 5G NAS 720 may include multiple 5G MM entities 726 and 728 and 5G session management (SM) entities 722 and 724. The legacy NAS 750 may include functional entities such as short message service (SMS) entity 752, evolved packet system (EPS) session management (ESM) entity 754, session management (SM) entity 756, EPS mobility management (EMM) entity 758, and mobility management (MM)/ GPRS mobility management (GMM) entity 760. In addition, the legacy AS 770 may include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). Note that as shown, the 5G MM may maintain individual connection management and registration management state machines for each connection. Additionally, a device (e.g., UE 106) may register to a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, as so forth) for both accesses.

Note that in various embodiments, one or more of the above-described functional entities of the 5G NAS and/or 5G AS may be configured to perform methods for determining and applying switching periods, e.g., in 5G NR systems and beyond, e.g., as further described herein.

### Switching Periods

NR switching periods is a topic of interest. Some UEs may require an amount of time (e.g., to adjust a transmitter) between transmitting on one frequency, carrier, channel, or band (or any combination thereof) and another frequency, carrier, channel, or band (or any combination thereof). Such a switch may be referred to as uplink (UL) transmission (Tx) switching. A switching period may be a time period to allow this to occur.

In some embodiments, a UE may be incapable of receiving on at least one of the frequencies, carriers, channels, or bands during the switching process (e.g., which may or may not take the same amount of time as a relevant switching period). For example, the UE may be able to receive on the switch-from band during the switching process, but may not be able to receive on the switch-to band during the switching process. Therefore, if a downlink (DL) transmission to the UE occurs during the switching process, the UE may not successfully receive the entire DL transmission. However, different UE capabilities and capability reporting are possible. For example, if a UE reports no DL interruption on both switch-to and switch-from bands, then UE may be able to receive on both.

For UL Tx switching in Rel-16, a radio resource control (RRC) parameter for the switching period location has been specified in the ServingCellConfig. The RRC parameter is uplinkTxSwitchingPeriodLocation. This parameter may be band specific. It may indicate whether the location of UL Tx switching period is configured in this uplink band in case of inter-band UL carrier aggregation (CA), supplementary uplink (SUL), or Next Generation (NG) E-UTRA NR Dual Connectivity EN-DC.

In the case of (NG)EN-DC, a network may (e.g., always, according to some embodiments) configure this field to TRUE for NR band. In other words, with (NG)EN-DC, the UL switching period may (e.g., always) occur on the NR band or may occur on the NR band by default.

In the case of inter-band UL CA or SUL, for dynamic uplink Tx switching between 2 bands with 2 uplink carriers or 3 uplink carriers, a network may configure this field to TRUE for the uplink carrier(s) on one band and configure this field to FALSE for the uplink carrier(s) on the other band. In other words, the network may select one band for the location of the switching period. This field may be set to the same value for all of the carriers on the same band.

Rel-16 NR may also specify that during the entire duration of this switching period, no UL transmissions is supported on the bands that are involved in the switching. For example, if there is switching from band A to band B and if switching period location is set to “True” for band A or band B, then no UL transmission may be supported on that band during this switching period.

Furthermore, a UE may report a parameter (e.g., uplinkTxSwitching-DL-Interruption-r16) that indicates that DL interruption on the band will occur during UL Tx switching. In other words, this parameter may indicate that the UE cannot receive DL communication during the switching process on the reported band. The UE may not be allowed to set this parameter for the band combination of SUL band+TDD band (e.g., where no DL interruption is allowed). This field may be encoded as a bit map, where bit N is set to “1” if DL interruption on band N will occur during uplink Tx switching. The leading/leftmost bit (bit 0) may correspond to the first band of this band combination, the next bit may correspond to the second band of this band combination and so on. The capability may not be applicable to the following band combinations, in which DL reception interruption may not be not allowed:
TDD+TDD CA with the same UL-DL pattern; and
TDD+TDD EN-DC with the same UL-DL pattern.

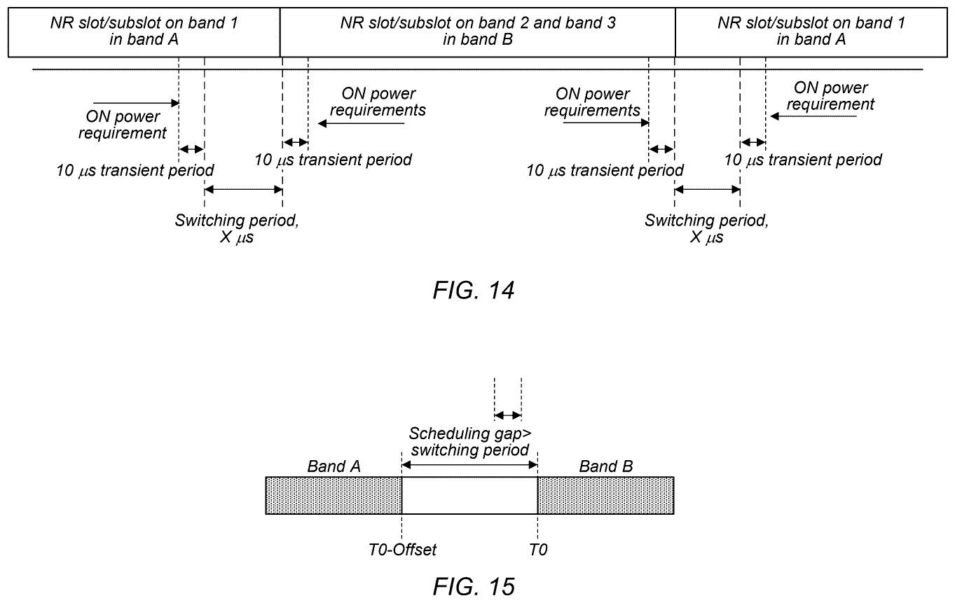

In the maintenance discussion for Rel-16 UL Tx switching, it has been discussed and clarified that the switching period location as currently specified may be applied mainly to the case when the scheduling gap is shorter than the duration of the switching process between the initial band before UL Tx switching and the final band after the UL Tx switching. See FIG. 14. Thus, the switching period location may be considered not applicable for the case when the scheduling gap is longer/equal than the duration of the switching process between the initial band before UL Tx switching and the final band after the UL Tx switching. See FIG. 15.

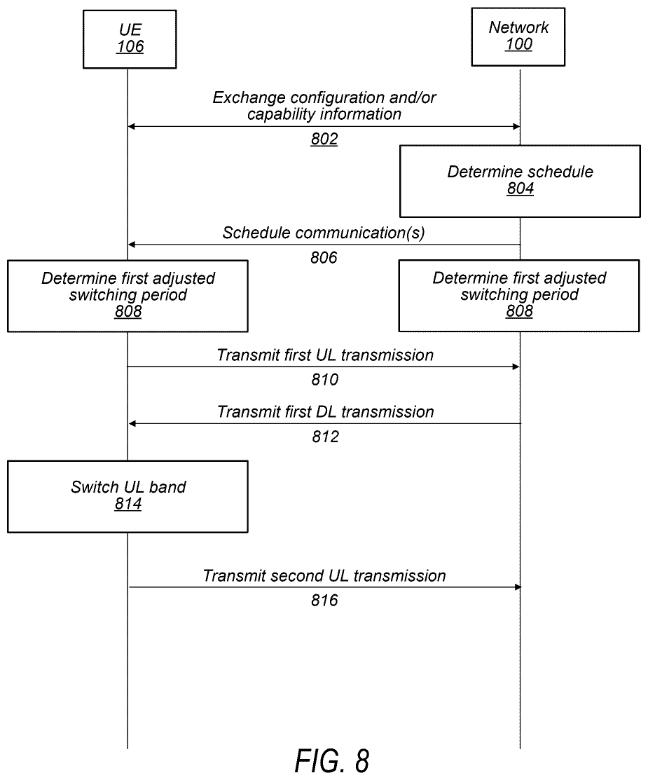

For the case when the scheduling gap is longer than or equal to the duration of the switching process between the initial band before UL Tx switching and the final band after the UL Tx switching, from UL transmission interruption point of view, it may not be necessary to know the exact location of switching process because there is not UL transmissions during the scheduling gap. However, a problem may arise from the DL interruption point of view, if reported by UE for the band(s) for band combination for UL Tx switching. From network perspective, if the specific location (e.g., of the UE's UL Tx switching process) is not known and it can be anywhere during the scheduling gap, then the network is not able to schedule DL transmissions during the entire scheduling gap (e.g., if DL interruption is reported by UE for those bands). Therefore, it may be desired that the switching process location shall be clarified and specified for this case as well. Based on current discussions, the view is that the switching process location may be anchored to start of the UL transmission on the switch-to band. In other words, the switching process may occur immediately prior to the beginning of the transmission on the new band. Thus, the switching period ends and right after that the transmission on the switch-to band may start. However, this could be problematic for UE's implementation if timing advance (TA) is not taken into account for DL interruption. FIG. 8 illustrates a method for adjustments to the timeline related to DL interruption time and/or switching period such that timing advance is taken into account and the issue is avoided, according to some embodiments.

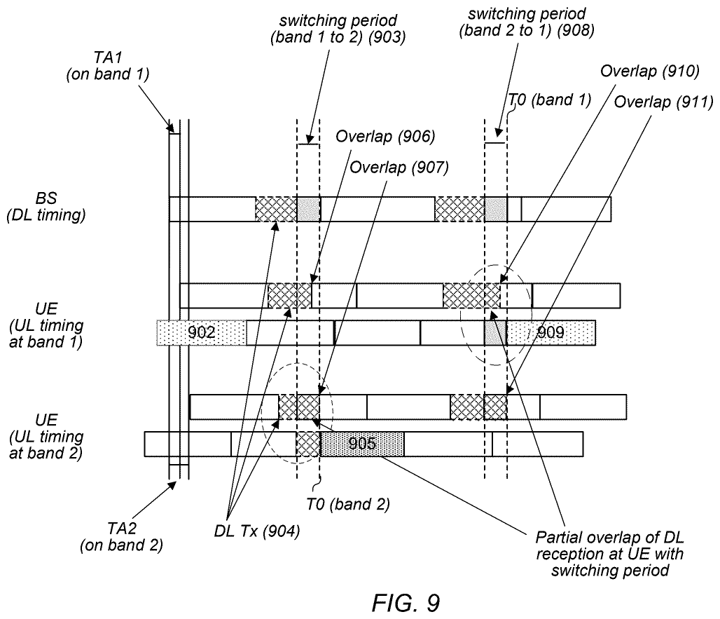

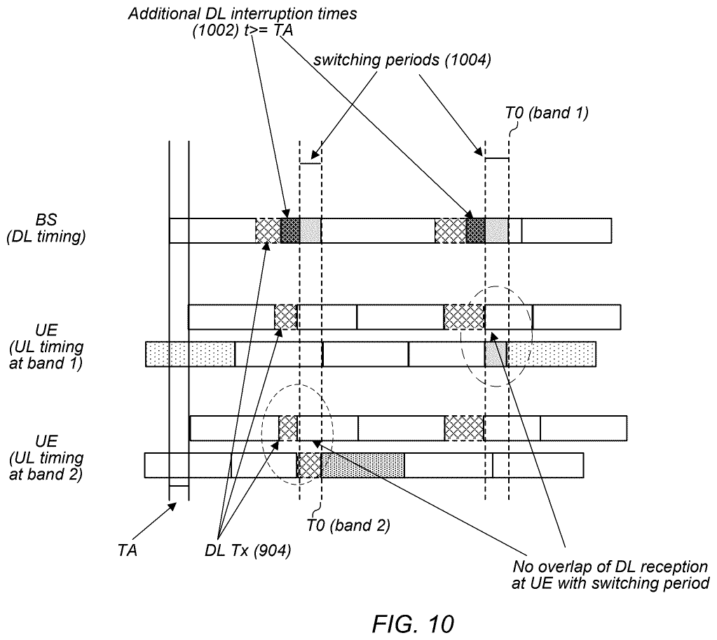

FIG. 9 illustrates an example sequence of transmissions where TA is not considered for adjusting switching period. As shown, a UE may use bands 1 and 2 to transmit to a BS of a network. Band 1 may have TA1 and band 2 may have TA2, relative to the timing of the BS. TA2 may be greater than TA1. The UE may transmit a first UL transmission (902) on band 1 with a switching period (903) prior to a second UL transmission (905) on band 2. The BS may transmit a first DL transmission (904) to the UE ending prior (e.g., in the BS timing) to the switching period (903). However, in the UE timing, the first DL transmission may overlap the switching period a first amount (906) in the timing for the first band and a second amount (907) in the timing of the second band (e.g., according to the TA1 and TA2). Similarly, a second switching period (908) may be scheduled prior to a third UL transmission (909) on band 1. Again, overlap (910, 911) of a second DL transmission and the switching period 908 may occur due to the timing advance. In some embodiments, the overlaps (907, 910) that occur on the switch-to band may cause reception problems (e.g., the UE may not be able to receive on the band that it is switching its transmitter to, but may be able to receive on the band it is switching its transmitter from). In other words, missed reception may occur at 907 and 910, but reception may occur at 906 and 911.

Techniques of FIG. 8 may allow for such DL transmissions to occur without overlapping the switching period(s) and/or without causing missed transmission or reception, according to some embodiments. Embodiments described herein provided systems, methods, and mechanisms for determining and applying switching periods, e.g., incorporating timing advance.

FIG. 8 illustrates a flow diagram of an example method of determining and applying switching periods, e.g., incorporating timing advance, according to some embodiments. For example, a UE and network may determine an adjusted switching period The method shown may be used in conjunction with any of the systems, methods, or devices shown in the Figures, among other devices. For example, a processor of a UE may be configured to cause the UE to perform aspects of the method. In various embodiments, some of the method elements shown may be performed concurrently, in a different order than shown, or may be omitted. Additional method elements may also be performed as desired. As shown, this method may operate as follows.

A UE, such as UE 106 and/or UE 107, may exchange with a network 100 (e.g., one or more entity of the network such as base station 102, etc.) configuration information and/or capability information (802), according to some embodiments. The configuration information and/or capability information may be exchanged via RRC and/or MAC signaling or control elements, among various possibilities.

As one possibility for capability information, the UE may inform the network about its UL Tx switching time requirements. For example, the UE may provide information about what (if any) bands (e.g. and/or frequencies, channels, or combinations thereof, etc.) it can switch between without a gap (or without a DL interruption). Similarly, the UE may provide information about what (if any) bands it can switch between with a gap (or with a DL interruption) and may provide information about the length(s) of the gap/interruption. It will be appreciated that such lengths may be specified specifically to particular band combinations and/or in a more general manner (e.g., a default gap length). In some embodiments, such a UL Tx switching time requirements may be used (possibly with adjustment unrelated to TA) as a base switching period (e.g., for band pairs). In some embodiments, a base switching period may be set in standards or otherwise determined based on other factors.

In some embodiments, one or more base switching period may be reported (by the UE, to the network) as “switching period” for one or more band pairs. For example, for band pair (A, B), UE may report one of the three values {35 us, 140 us, 210 us} (note, these values are only example values, others may be used). This switching period may be reported for all possible band pairs within a combination. For example, if there are 3 bands configured for UL Tx switching in a combination (A, B, C), then UE can report switching period values for each pair including (A, B), (A, C) and (B, C). Similarly, switching periods may be reported for 2 or 4 band combinations, etc. Further, switching periods may be reported for multiple switch-to and/or switch from bands. For example, if there are 4 bands configured for UL Tx switching in a combination (A, B, C, D), then a switching period for switching from bands A+B to bands C+D may be reported, etc.

The network may transmit configuration information to the UE for determining a switching period duration and/or location, e.g., accounting for TA. In some embodiments, this configuration may be set in standards (e.g., 3GPP) and thus some or all aspects of may not be transmitted in the configuration information.

As one possibility, the network and/or standard may configure the UE to use a base switching period (e.g., duration) in combination with an adjustment for TA. The adjustment for TA may be denoted as “t” herein and in the figures, but it will be appreciated that other notations may be used as desired. The value(s) of t may be determined by UE and/or network based on the TA(s) required by the UE to align the UL and DL timing for the involved bands.

In one example, the total duration of DL interruption (e.g., switching period) time may be at least increased before the start of a switching period as illustrated in the FIG. 10, according to some embodiments. For example, when DL interruption is reported by the UE for the bands involved in UL Tx switching and if the switching period location precedes the start of the UL transmission on the switch-to band (e.g., at time T0), then the DL interruption time may be increased relative to switching period duration by a time t. As shown, additional DL interruption times (1002) may be added (at the BS timing) prior to scheduled switching periods (1004). The scheduled switching period may be a base switching period and the additional DL interruption time may be a time adjustment value (e.g., related to TA). This adjustment may avoid overlap of the DL reception with the switching period (using the UE timing at bands 1 and 2). The additional DL interruption time may be of length t, where t is greater than or equal to TA. The DL transmission 904 may complete during the additional DL interruption time 1002, but (at the UE timing) at or prior to the beginning of the switching period 1004. Thus, reception of the DL transmission may be successful and the UE may perform the UL Tx switch during the switching period.

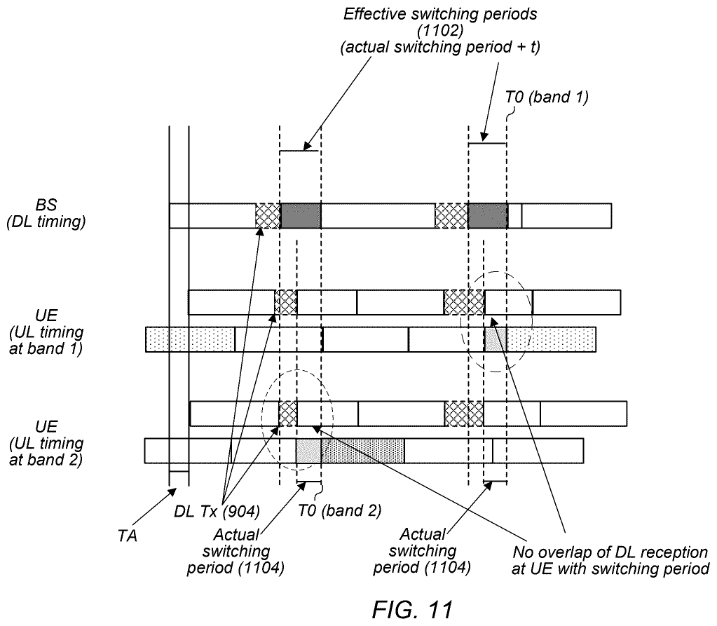

In another example, when DL interruption is reported by the UE for the bands involved in UL Tx switching and if the switching period location precedes the start of the UL transmission on the switch-to band (e.g., at time T0), then an effective switching period (1102) may be (e.g., set to be) longer than a reported switching period duration (e.g., base switching period) by a time t, as illustrated in the FIG. 11, according to some embodiments. As shown, an effective switching period 1102 may have a duration equal to an actual/reported switching period (1104, e.g., base switching period) plus t, where t is greater than or equal to TA. Thus, for time t at the beginning of the effective switching period, the DL interruption is not expected. In other words, for time t prior to the beginning for the actual switching period, DL traffic may not be expected. The DL transmission 904 may complete (at the UE timing) during the effective switching period 1102, but at or prior to the beginning of the actual switching period 1104. Thus, reception of the DL transmission may be successful and the UE may perform the UL Tx switch during the actual switching period.

In some embodiments, a single value to t may be used. In other embodiments, multiple, different values of t may be used for different bands or situations. In some embodiments, a value of t may be determined by UE and/or network based on the timing advance required by the UE to align the UL and DL timing for the switch-to band (e.g., the band that will be used for UL transmission subsequent to the switch). This means that the value of t (and hence a duration of an adjusted switching period, e.g., total DL interruption time duration or effective switching period) could be different depending on the switch-to band. Thus, different values of t may be associated with different switch-to bands.

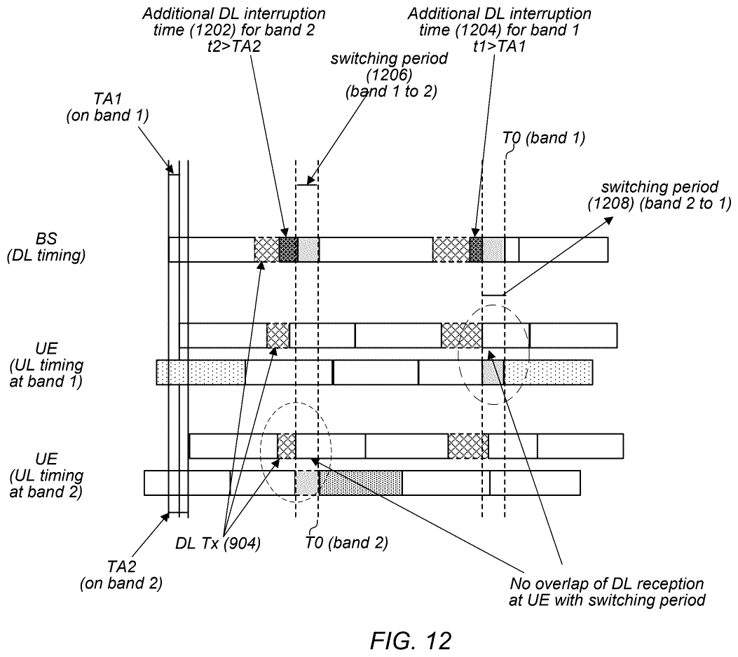

In one example, for the case of multiple timing advance groups (TAGs), when DL interruption is reported by the UE for the bands involved in UL Tx switching and if the switching period location precedes the start of the UL transmission on the switch-to band, (e.g., at time T0), then the DL interruption time may be increased relative to switching period duration by time t, where t is specific to the band TAG. FIG. 12 illustrates an example to additional DL interruption times (1202, 1204) with multiple TAGs, according to some embodiments. As shown, an adjustment t2 (1202, t2 greater than or equal to TA2 associated with band 2) may be used at the time of a switch to band 2 and an adjustment t1 (1204, t1 greater than or equal to TA1 associated with band 1) may be used at the time of a switch to band 1. Thus, the duration of DL interruption time is at least increased before the start of switching period (1206, 1208) by t1 or t2, according to the switch-to band. Accordingly, the BS may conclude transmission of the DL transmission prior to the additional interruption time (1202, 1204) (at the BS timing). The UE may receive the last portion of the DL transmission prior to the switching period (at the UE timing of the switch-to band). Note that for the first switch (gap 1206), the reception may complete prior to the gap in the timing of both bands (e.g., because TA2>TA1). However, for the second switch (gap 1208), the reception may overlap the gap at the switch-from band, but not the switch-to band. Thus, reception of the DL transmission may be successful and the UE may perform the UL Tx switch during the switching period (in the timing of the switch-to band).

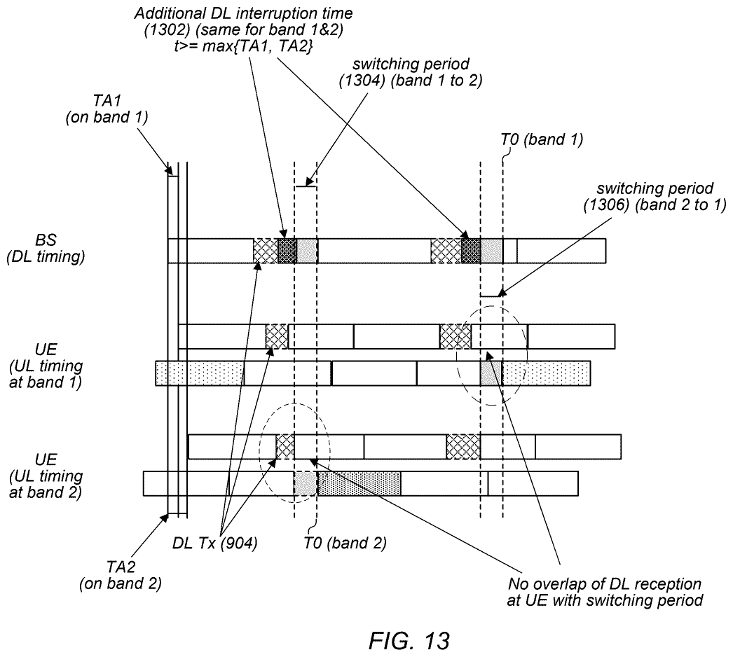

In another example, for the case of multiple TAGs, when DL interruption is reported by the UE for the bands involved in UL Tx switching and if the switching period location precedes the start of the UL transmission on the switch-to band, (e.g., at time T0), then the DL interruption time may be increased relative to a base switching period duration by a time t. As shown in FIG. 13, time t may be determined by UE and/or BS based on the maximum value of the timing advance required by the UE to align the UL and DL timing for the involved band pairs, according to some embodiments. In other words, a single value of t may be used (e.g., regardless of the switch-to band) for additional DL interruption time (1302), so that the value of t is greater than a maximum TA. For example, t may be greater than the maximum of TA1 or TA2. The duration of DL interruption time may be at least increased before the start of switching period (1304, 1306) by t. Accordingly, the BS may conclude transmission of the DL transmission prior to the additional interruption time (1302) (at the BS timing). The UE may receive the last portion of the DL transmission prior to the switching period (at the UE timing of both bands). Note that for both switch gaps (1304, 1306), the reception may complete prior to the beginning of the switch gap in the timing of band 1, but at the beginning of the switch car in the timing of band 2 (e.g., because TA2>TA1). Thus, reception of the DL transmission may be successful and the UE may perform the UL Tx switch during the switching period (in the timing of the switch-to band).

In another example, for the case of multiple TAGs, when DL interruption is reported by the UE for the bands involved in UL Tx switching and if the switching period location precedes the start of the UL transmission on the switch-to band, (e.g., at time T0), then an effective switching period may be longer than the reported switching period duration by a time t. As one possibility, time t may be determined by UE and/or network based on the timing advance required by the UE to align the UL and DL timing for the switch-to band. This means that the effective switching period may be different depending on the switch-to-band. As another possibility, time t may be determined by UE and/or network based on the maximum value of the timing advance required by the UE to align the UL and DL timing for the involved band pairs. In this case, a single value of t may be used. In either possibility, for time t at the beginning of the effective switching period, the DL interruption may not be expected. As in FIG. 11, the DL transmission 904 may complete (at the UE timing) during the effective switching period 1102, but at or prior to the beginning of the actual switching period 1104. Thus, reception of the DL transmission may be successful and the UE may perform the UL Tx switch during the actual switching period.

In some embodiments, the time t may be explicitly configured/indicated by the network to allow similar assumption about the start and duration of DL interruption time at UE and network. For example, a TA command indicated to UE by the network may also be applied for DL interruption time. In other words, a TA value from a TA command may be applied as a value of t. Alternatively, an explicit value for time t for DL interruption time determination may be signaled to the UE.

In some embodiments, the time t may not be explicitly configured/indicated by the network. Thus, the time t may be determined by the UE and network separately. For example, the time t may be determined based on a maximum round trip delay time (e.g., as measured by the UE and/or network). Such a determination may be made for individual bands/TAGs, and thus different values of t may be used, according to some embodiments. Alternatively, an average or maximum value (e.g., across bands or TAGs) may be used as a single, common value of t. Further, to account for error in the separate determination, an additional delta time t′ may be applied to time t, according to some embodiments. However, it will be appreciated that t′ may not be applied or may be set to zero in some embodiments. Among various possibilities, delta time t′ may be configured by the network in various ways: per UE; per band-combination per UE; per band per UE; and/or signaled/updated as needed, for example via MAC CE and/or DCI.

It will be appreciated that the UE may obtain configuration information associated with a first time adjustment value for uplink transmission switching (e.g., t), in various ways. As one possibility, the UE may generate the configuration information. For example, the UE may determine t from standards information or other information stored on the device. As another possibility, the UE may receive the information from the network (e.g., via RRC or other signaling). As a further possibility, the UE may generate some configuration information and receive other information, and thus may use a combination of the information obtained in each way.

The network may determine a schedule for communication with the UE (804), according to some embodiments. The schedule may include first UL communication from the UE at a first time on a first band and second UL communication at a second time on a second band. In other words, the schedule may include a UL Tx switch at the UE. The schedule may include DL communication, e.g., potentially in between the first and second UL communications.

The network may transmit one or more messages to the UE to schedule communications (e.g., according to the schedule(s) of 804) (806), according to some embodiments. The message(s) may be DCI message(s), such as UL grant, etc.

It will be appreciated that the schedule (804) may be determined at multiple times. Similarly, messages (806) indicating portions of the schedule may be sent at different times. For example, at a first time the network may determine a first portion of the schedule and send a first DCI message/grant indicating that portion. At a second time, the network may determine a second portion and send a second DCI/grant, etc.

The network may provide TA information to the UE, according to some embodiments. The TA information may be provided during/with 802 and/or 806, among various possibilities. For example, the network may provide TA values or TA commands for one or more bands. For example, a TA command may be transmitted via MAC CE. This command may consist of 8 bits, where 3 bits may be used to indicate the TAG ID and 6 bits used to indicate TA value, among various possibilities.

The network and UE may (e.g., separately) determine a first adjusted switching period (808), according to some embodiments. The first adjusted switching period may be an amount of time (and the beginning/end of that duration) for which the UE will be unavailable to receive DL communication (e.g., on at least the switch-to band) while performing the UL Tx switch (e.g., between the first UL communication from the UE at the first time on the first band and the second UL communication at the second time on the second band, as in 804/806). For example, the network and UE may determine a base switching period (e.g., as indicated in the UE's capability information in 802). It will be appreciated that the base switching period may be specific to the bands involved or may be more general. Further, the network and UE may determine a first adjustment value (t, as discussed above) and adjust the base switching period using the adjustment value.

The UE may transmit the first UL transmission on the first band (810), according to some embodiments.

The network may transmit a first DL transmission to the UE (812), according to some embodiments. The first DL transmission may be subsequent to the first UL transmission. The first DL transmission may use the first and/or second bands (and possibly others also). The network may end the first DL transmission at or prior to the beginning of the first adjusted switching period (at the BS/network timing). Thus, the UE may receive the first DL transmission by the beginning of the base (e.g., unadjusted) switching period. Note that, in some cases, the UE may receive at least a portion of the DL transmission during the first adjusted switching period (at the UE timing). The network may avoid transmitting to the UE (e.g., at least on bands involved in the Tx switch) during the first adjusted switching period (at the BS/network timing).

The UE may perform a UL Tx switch to the second band (814), according to some embodiments. The switch may occur at the UE during the base (e.g., unadjusted) switching period.

In some embodiments, the UE may not transmit or receive during the base (e.g., unadjusted) switching period.

The UE may transmit the second UL transmission on the second band (816), according to some embodiments. The second UL transmission may be performed after (e.g., potentially immediately following) the base (e.g., unadjusted) switching period.

### Additional Information and Examples

In some embodiments, if the timing advance value to be applied at the switch-to band is longer than the duration of the switching period, then DL interruption may be assumed by the UE during the entire duration of scheduling gap. For example, DL may not occur during the switching period (if DL interruption is reported by UE). However, for the remaining part of scheduling gap (e.g., before/after the switching period), the UE may be able to receive DL. The scheduling gap may be from the end of one UL transmission to the start of next UL transmission. During this scheduling gap, some part may contain switching period and in this switching period there can be no DL transmission (if reported by UE for the bands). But for other remaining part of scheduling gap, DL can be scheduled. In some embodiments, the DL transmission may be further limited before the switching period so that TA effect is taken into consideration and DL may not overlap with actual/base switching period.

It will be appreciated that aspects of the method of FIG. 8 may be described with respect to two bands (e.g., one switch-to band and one switch-from band). However, the method may be applied to larger numbers of bands. For example, if there are bands A, B, C, and D, band switching may occur in various combinations such as: A->B+C; A+B->C; A+B->C+D, etc. In these cases, methods discussed above may be applied for adjusting the switching period. For example, in a case when there are 2 (or more) switch-to bands, then a maximum TA value from the 2 (or more) switch-to bands may be taken for switching period adjustment. As another possibility, a maximum TA among all bands (including both switch-to and switch-from bands) may be applied. Thus, the method may further comprise the cellular network scheduling UL transmissions on multiple bands simultaneously. The UE and network may determine adjusted switching gap and related information based on the switch to bands and/or other bands.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
obtaining, from a cellular network, configuration information associated with a first time adjustment value for uplink transmission switching, wherein the first time adjustment value is based on a timing advance;
receiving, from the cellular network, scheduling information to schedule:
a first uplink (UL) transmission on a first band; and
a second UL transmission on a second band different from the first band;
determining a first adjusted switching period between the first UL transmission and the second UL transmission, the first adjusted switching period based on a base switching period adjusted by the first time adjustment value;
transmitting, to the cellular network, the first UL transmission on the first band;
receiving, from the cellular network, a first downlink (DL) transmission after transmission of the first UL transmission;
during the base switching period, switching a transmitter to the second band, wherein the base switching period begins after reception of the first DL transmission and continues during the first adjusted switching period; and
transmitting, to the cellular network, the second UL transmission on the second band after the base switching period.

2. The method of claim 1, further comprising:
receiving, from the cellular network, timing advance command comprising a first time advance value for a first timing advance group (TAG); and
determining the first time adjustment value related to timing advance based on the first time advance value, wherein the first adjusted switching period has a duration equal to the base switching period plus the first time adjustment value.

3. The method of claim 2, wherein the first time adjustment value is equal to the first time advance value.

4. The method of claim 2, wherein the first time adjustment value is greater than the first time advance value.

5. The method of claim 1, further comprising:
receiving, from the cellular network, a first timing adjustment value; and
determining the first adjusted switching period by determining a start of the first adjusted switching period to be earlier than a start of the base switching period by the first timing adjustment value, wherein a duration of the first adjusted switching period is equal to the base switching period plus the first timing adjustment value.

6. The method of claim 1, further comprising:
determining a maximum round trip delay time to and from the cellular network, wherein the first time adjustment value is based on the maximum round trip delay time.

7. The method of claim 6, wherein the first time adjustment value is equal to the maximum round trip delay time.

8. The method of claim 6, wherein the first time adjustment value is equal to the maximum round trip delay time plus a delta time configured by the cellular network.

9. The method of claim 8, wherein the delta time is configured either:
per band; or
per band combination.

10. The method of claim 8, wherein the delta time is configured using user equipment specific signaling.

11. The method of claim 8, wherein the delta time is configured using at least one of:
downlink control information; or
media access control (MAC) control element (CE).

12. The method of claim 1, wherein:
the first band is associated with a first timing advance;
the second band is associated with a second timing advance different from the first timing advance; and
the first time adjustment value is based on a maximum of the first timing advance and the second timing advance.

13. The method of claim 1, wherein:
the first band is associated with a first timing advance;
the second band is associated with a second timing advance different from the first timing advance; and
the first time adjustment value is based on the second timing advance.

14. The method of claim 13, further comprising:
determining a second adjusted switching period between the second UL transmission and a third UL transmission on the first band, the second adjusted switching period based on the base switching period adjusted by a second time adjustment value related to timing advance, wherein the second time adjustment value is based on the first timing advance.

15. (canceled)

16. (canceled)

17. A method, comprising:
determining, configuration information for a user equipment (UE) configuration information associated with a first time adjustment value for uplink transmission switching, wherein the first time adjustment value is based on a timing advance;
transmitting, to the UE, scheduling information to schedule:
a first uplink (UL) transmission on a first band; and
a second UL transmission on a second band different from the first band;
determining a first adjusted switching period between the first UL transmission and the second UL transmission, the first adjusted switching period based on a base switching period adjusted by the first time adjustment value related to timing advance;
receiving, from the UE, the first UL transmission on the first band;
transmitting, to the UE, a first downlink (DL) transmission after reception of the first UL transmission and prior to the first adjusted switching period; and
receiving, from the UE, the second UL transmission on the second band after the first adjusted switching period.

18. The method of claim 17, further comprising:
determining a maximum round trip delay time to and from the UE, wherein the first time adjustment value is based on the maximum round trip delay time.

19. The method of claim 17, further comprising:
determining a first time advance value for a first timing advance group (TAG);
transmitting, to the UE, timing advance command comprising the first time advance value; and
determining the first time adjustment value related to timing advance based on the first time advance value, wherein the first adjusted switching period has a duration equal to the base switching period plus the first time adjustment value.

20. The method of claim 17, further comprising:
determining a first time a timing adjustment value;
transmitting, to the UE, the first timing adjustment value; and
determining the first adjusted switching period by determining a start of the first adjusted switching period to be earlier than a start of the base switching period by the first timing adjustment value, wherein a duration of the first adjusted switching period is equal to the base switching period plus the first timing adjustment value.

21. An apparatus, comprising:
a processor configured to, when executing instructions stored in a memory, perform operations comprising:
obtaining, from a cellular network, configuration information associated with a first time adjustment value for uplink transmission switching, wherein the first time adjustment value is based on a timing advance;
receiving, from the cellular network, scheduling information to schedule:
a first uplink (UL) transmission on a first band; and
a second UL transmission on a second band different from the first band;
determining a first adjusted switching period between the first UL transmission and the second UL transmission, the first adjusted switching period based on a base switching period adjusted by the first time adjustment value;
transmitting, to the cellular network, the first UL transmission on the first band;
receiving, from the cellular network, a first downlink (DL) transmission after transmission of the first UL transmission;
during the base switching period, switching a transmitter to the second band, wherein the base switching period begins after reception of the first DL transmission and continues during the first adjusted switching period; and
transmitting, to the cellular network, the second UL transmission on the second band after the base switching period.

22. The apparatus of claim 21, the operations further comprising:
receiving, from the cellular network, timing advance command comprising a first time advance value for a first timing advance group (TAG); and
determining the first time adjustment value related to timing advance based on the first time advance value, wherein the first adjusted switching period has a duration equal to the base switching period plus the first time adjustment value.
